(19) United States
(12) Patent Application Publication
(10) Pub. No.: US 2017/0022751 A1
(43) Pub. Date: Jan. 26, 2017

(54) SOUNDPROOF DOOR FOR USE IN REDUCTION OF SOUND TRANSMITTED FROM ONE SIDE OF THE DOOR TO THE OTHER SIDE

(71) Applicant: NAN YA PLASTICS CORPORATION, Taipei (TW)

(72) Inventor: Kuei Yung WANG, Taipei (TW)

(21) Appl. No.: 14/808,351

(22) Filed: Jul. 24, 2015

(51) Int. Cl. E06B 5/20

(52) U.S. Cl. CPC E06B 5/20

(57) ABSTRACT

A soundproof door is disclosed to has a multiple-layered core to form a concrete inner portion of the soundproof door, the multiple-layered core due to particularly constituted by having a soft-soundproofing core interleaved in between two spaced hard-soundproofing cores to form as a whole as a sandwich structure are excellent in sound isolation for soundproof door, and the soundproof door at least has an STC of 30, determined in accordance with ASTM E413-10 and E90-09, to minimize the transmission of sound from one side of the soundproof door to the other side.

### BACKGROUND OF THE PRESENT INVENTION

1. Field of the Invention

The present invention relates to a soundproof door, and more particularly, to an improved soundproof door having an STC number greater than of STC 30 determined in accordance with ASTM E413-10 and E90-09.

2. Description of Related Art

A soundproof door is a door which has been designed or retrofitted to cut out as much external noise as possible.

However, most soundproof doors currently used in prior art are wooden doors or synthesized plastic doors, those doors are poor in sound isolation or acoustic insulation.

### SUMMARY OF THE INVENTION

The major purpose of the present invention is to provide an improved soundproof door for use in reduction of sound transmitted from one side of the door to the other side, which improvement includes the soundproof door has a multiple-layered core to form a concrete inner portion of the soundproof door, the multiple-layered core particularly constituted by having a soft-soundproofing core interleaved in between two spaced hard-soundproofing cores to form as a whole as a sandwich structure are excellent in sound isolation for soundproof door, and the soundproof door at least has an STC of 30 determined in accordance with ASTM E413-10 and E90-09, so that the soundproof door may minimize the transmission of sound from one side of the soundproof door to the other side.

The structural composition of the soundproof door comprises two door skins one formed as a front door skin and the other formed as a rear door skin for the soundproof door respectively; a quadrilateral frame constituted by a top rail member, a bottom rail member, a left stile member and a right stile member to seal the perimeter of the door skins; and a multiple-layered core having function of sound isolation to form a concrete inner portion of the door, wherein the multiple-layered core comprises two spaced hard-soundproofing cores and a soft-soundproofing core interleaved in between the spaced hard-soundproofing cores to constitute with a sandwich structure.

The above-mentioned soundproof door may further comprises one or more reinforced members in parallel set up alongside one or more sides of the soft-soundproofing core, and both the soft-soundproofing core and each the reinforced member are interleaved in between the two spaced hard-soundproofing cores to constitute with a sandwich structure.

Another structural composition of the soundproof door comprises two door skins one formed as a front door skin and the other formed as a rear door skin for the soundproof door respectively; a quadrilateral frame constituted by a top rail member, a bottom rail member, a left stile member and a right stile member to seal the perimeter of the door skins; one or more reinforced members in parallel set up alongside one or more inner sides of the quadrilateral frame; and a multiple-layered core having function of sound isolation to form a concrete inner portion of the door, wherein the multiple-layered core comprises two spaced hard-soundproofing cores and a soft-soundproofing core interleaved in between the spaced hard-soundproofing cores to constitute with a sandwich structure.

The hard-soundproofing core may be made of either a single-layered soundproofing core or a multiple-layered soundproofing core constituted by two or more the single-layered soundproofing cores.

The hard-soundproofing core is made of wood plate, iron plate, calcium silicate board, gypsum board, magnesium oxide board, silicon magnesium board, glass fiber composite board or ceramic composite board.

The soft-soundproofing core is made of rock wool fiber board, ceramic fiber wool board, phenolic foaming board, glass fiber board, closed cell polyurethane foaming board, opened cell polyurethane foaming board, expandable polystyrene foaming board or expandable polyethylene foaming board.

The reinforced member is made of hard PVC board, PVC composite extrusion board, PS board, ABS board, hardwood board, high density particle board or LVL board.

### BRIEF DESCRIPTION OF THE DRAWINGS

FIG. 1 is a schematic drawing of the soundproof door of the invention;

FIG. 2 is a partial enlargement of cross-sectional drawing along line 2-2 of the soundproof door in FIG. 1;

FIG. 3 is a partial enlargement of cross-sectional drawing along line 3-3 of the soundproof door in FIG. 1;

FIG. 4 is a schematic drawing of another embodiment of the soundproof door of the invention;

FIG. 5 is a partial enlargement of cross-sectional drawing along line 5-5 of the soundproof door in FIG. 4;

FIG. 6 is a partial enlargement of cross-sectional drawing along line 6-6 of the soundproof door in FIG. 4;

FIG. 7 is a schematic drawing of further another embodiment of the soundproof door of the invention;

FIG. 8 is a partial enlargement of cross-sectional drawing along line 8-8 of the soundproof door in FIG. 7; and

FIG. 9 is a partial enlargement of cross-sectional drawing along line 9-9 of the soundproof door in FIG. 7.

### DETAILED DESCRIPTION OF THE INVENTION

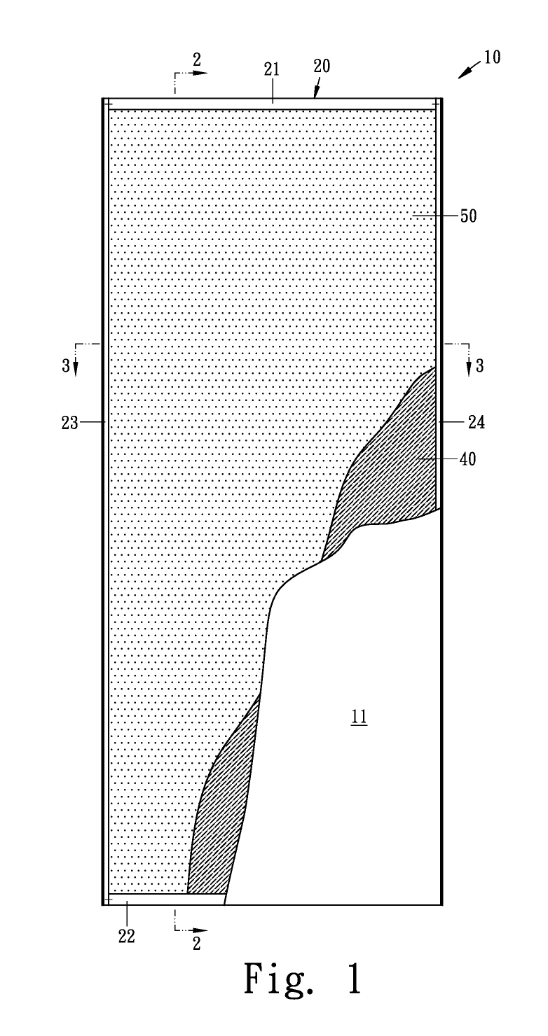

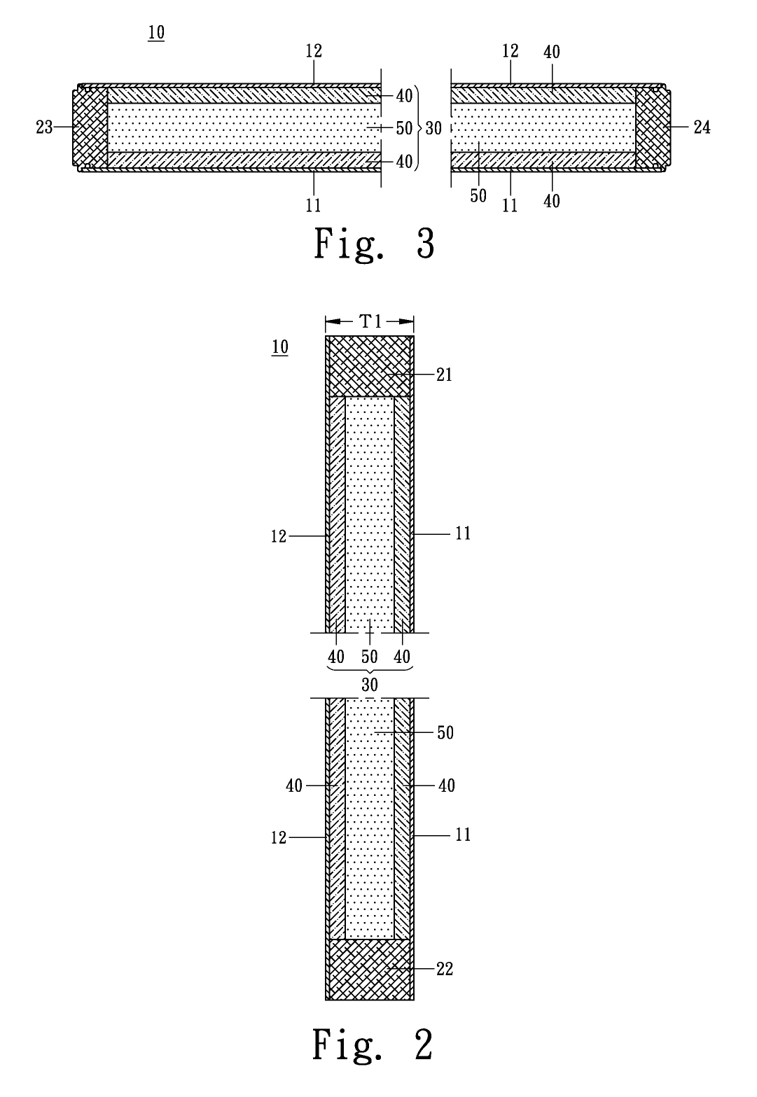

As shown in from FIG. 1 to FIG. 3, a soundproof door 10 disclosed in this present invention has a total thickness T1 ranged from 30 mm to 70 mm and comprises two door skins 11 and 12 formed as front door skin and rear door skin for the soundproof door 10 respectively, a quadrilateral frame 20 constituted by a top rail member 21, a bottom rail member 22, a left stile member 23 and a right stile member 24 to seal the perimeter of door skins 11 and 12 of the soundproof door 10, and a multiple-layered core 30 to form a concrete inner portion of the soundproof door 10.

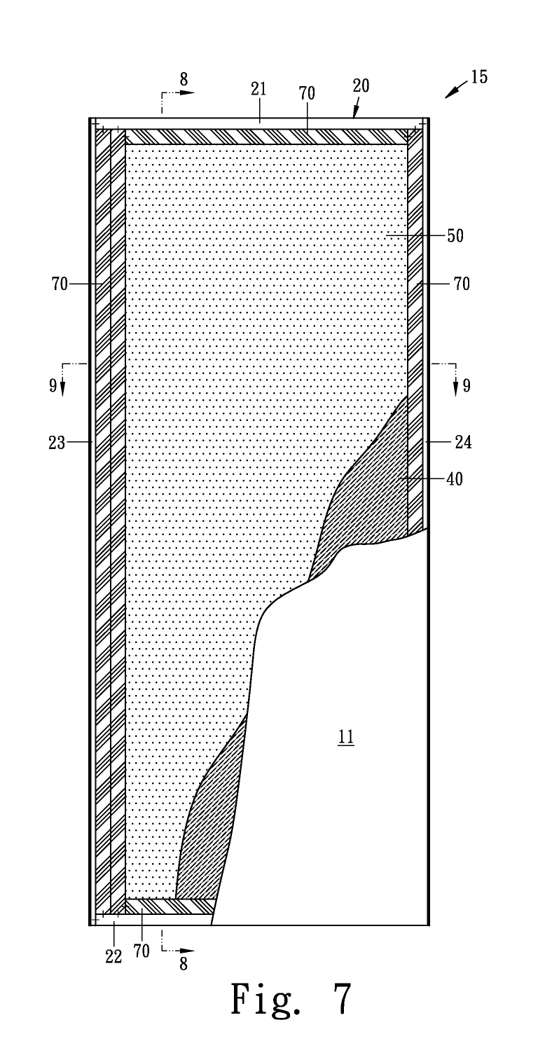

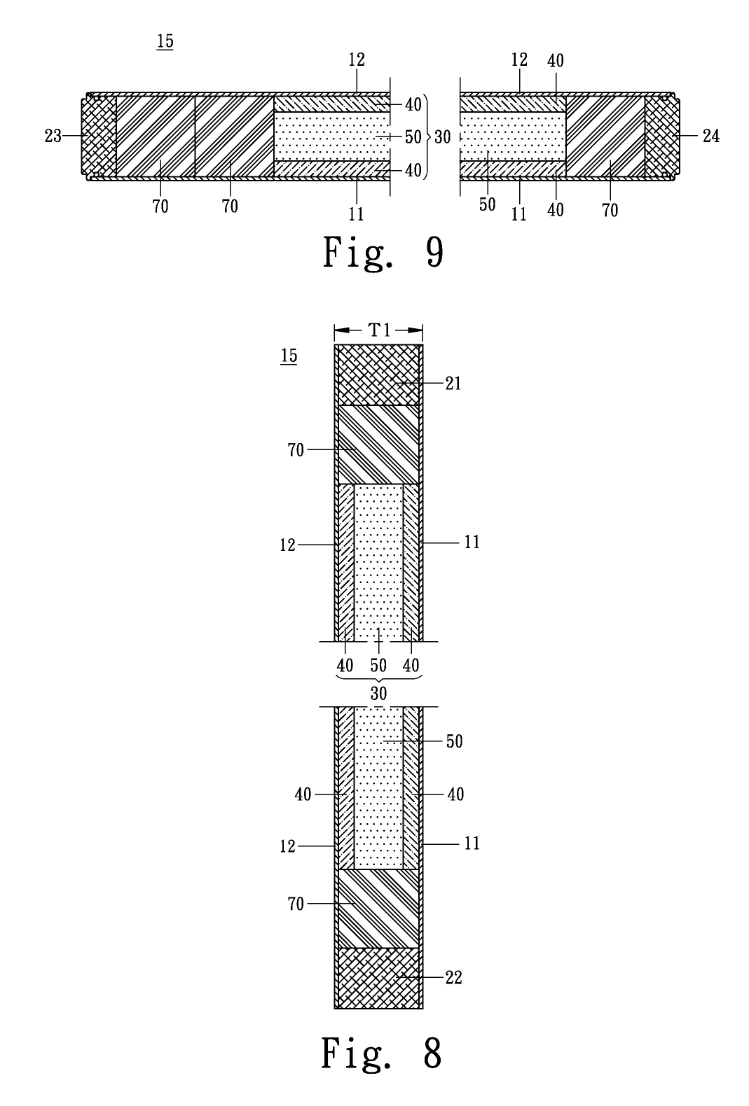

As shown in from FIG. 7 to FIG. 9, another embodiment of the soundproof door 15 of the present invention still has a total thickness T1 ranged from 30 mm to 70 mm and comprises the door skins 11 and 12 of the soundproof door 15, the quadrilateral frame 20 to seal the perimeter of door skins 11 and 12, one or more reinforced members 70 in parallel set up alongside one or more inner sides of the quadrilateral frame 20 of the soundproof door 15, and the multiple-layered core 30 to form a concrete inner portion of the soundproof door 15.

Particularly, the multiple-layered core 30 of the soundproof door 10 or 15 of the present invention has function of sound isolation to minimize the transmission of sound from one side of the soundproof door 10 of 15 to the other side.

The door skin 11 or 12 has a thickness of 1-5 mm and is made of fiber reinforced plastic (FRP) sheet, SMC sheet, BMC sheet, wood plate, iron plate, PVC sheet, PS sheet, ABS sheet or laminated veneer lumber (LVL) sheet. Wherein the SMC sheet is made of fiber reinforced plastic (FRP) by sheet molding compound method, and the BMC sheet is made of fiber reinforced plastic (FRP) by Bulk Molding Compound method.

Further, the door skin 11 or 12 can be shaped either as a flat door skin having a flat surface or as a panel door skin having decorative panel patterns formed on the door surface. The door skin 11 or 12 may have a smooth surface without wood grain or with imitating wood grain. The door skin 11 or 12 may have a rough back surface for increasing the binding force when they are bond together with the quadrilateral frame 20 and the multiple-layered core 30, or further with the reinforced member 70.

The quadrilateral frame 20 including the top rail member 21, the bottom rail member 22, the left stile member 23 and the right stile member 24 is made of hard PVC board, foamed PVC board, PVC composite extrusion board, hardwood board, high density particle board, laminated veneer lumber (LVL) board, stainless steel plate, galvanized and coated steel plate or calcium silicate plate.

The multiple-layered core 30 at least comprises two spaced hard-soundproofing cores 40 and a soft-soundproofing core 50 interleaved in between the spaced hard-soundproofing cores 40 to constitute with a sandwich structure.

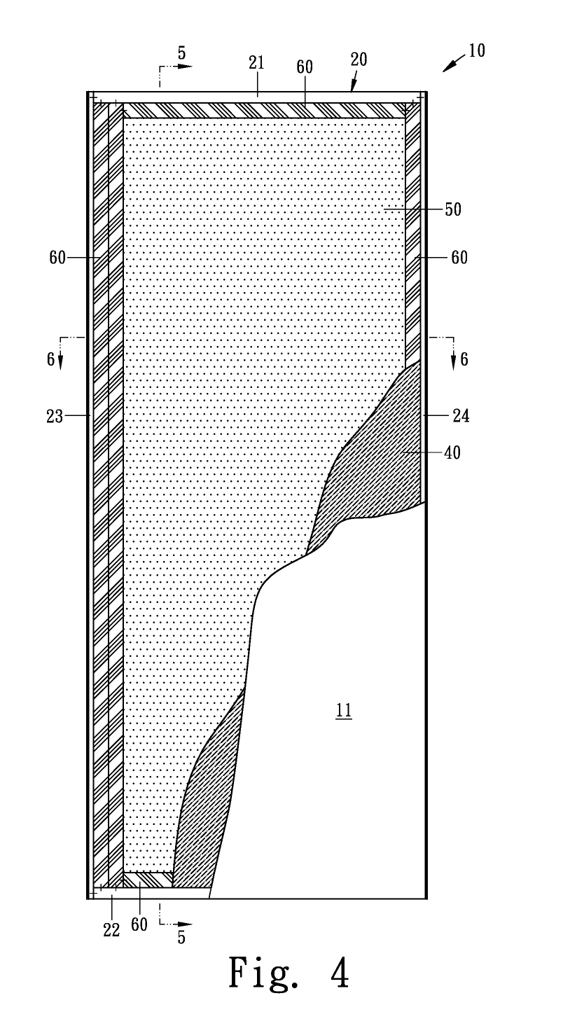

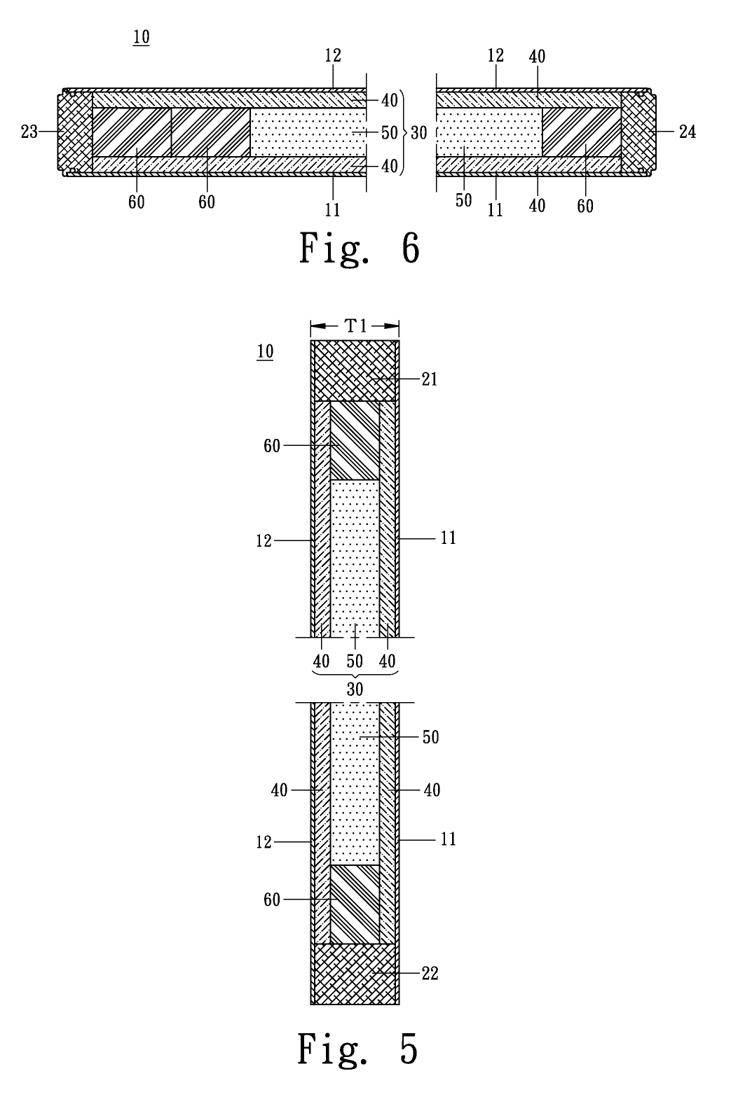

As shown in from FIG. 4 to FIG. 6, another practical embodiment of the multiple-layered core 30 comprises the spaced hard-soundproofing cores 40, the soft-soundproofing core 50 and one or more reinforced members 60 in parallel set up alongside one or more sides, preferably each side, of the soft-soundproofing core 50 thereof, and more particularly both the soft-soundproofing core 50 as well as the reinforced member 60 are interleaved in between the two spaced hard-soundproofing cores 40 to constitute with a sandwich structure.

The hard-soundproofing core 40 has a thickness of 3-12 mm and is made of either a single-layered soundproofing core or a multiple-layered soundproofing core constituted by two or more the single-layered soundproofing cores.

The hard-soundproofing core 40 has an excellent soundproofing ability to preferably block sound with high frequency over 500 Hz and is made of wood plate, iron plate, calcium silicate board, gypsum board, magnesium oxide board, silicon magnesium board, glass fiber composite board or ceramic composite board.

The soft-soundproofing core 50 has an excellent soundproofing ability to preferably block sound with low frequency beneath 500 Hz and is made of rock wool fiber board, ceramic fiber wool board, phenolic foaming board, glass fiber board, closed cell polyurethane foaming board, opened cell polyurethane foaming board, expandable polystyrene (EPS) foaming board or expandable polyethylene (EPE) foaming board.

The reinforced member 60 or 70 has an excellent rigidity and is made of hard PVC board, PVC composite extrusion board, PS board, ABS board, hardwood board, high density particle board or LVL board.

The following examples are recited to demonstrate that the soundproof door 10 or 15 of the present invention if measured and evaluated for sound transmission class (STC) test has a STC number greater than STC 30 for door, preferably greater than STC 33 for door, to minimize the transmission of sound at frequency of 500 Hz from one side of the soundproof door 10 of 15 to the other side.

### Sound Transmission Class (STC) Test:

The Sound Transmission Class (STC) is the most common sound reduction measurement in use, which is determined in accordance with both ASTM E413-10 (Classification for Rating Sound Insulation) and ASTM E90-90 (Standard Test Method for Laboratory Measurement of Airborne Sound Transmission Loss of Building Partitions and Elements).

Higher STC is generally better to reduction of sound vibration as it travels from one side of a door to the other.

### EXAMPLE 1

A soundproof door having a total thickness T1 of 45 mm is assembled according to the structural composition shown as FIGS. 4-6.

The door skins 11 and 12 have a thickness of 2 mm and are made of SMC sheet, the quadrilateral frame 20 have a thickness of 41 mm and is made of laminated veneer lumber (LVL) board, and the multiple-layered core 30 comprises the spaced hard-soundproofing cores 40 each having a thickness of 8 mm and made of silicon magnesium board, the soft-soundproofing core 50 having a thickness of 25 mm and made of rock wool fiber board, and four reinforced members 60 each having a thickness of 25 mm and in parallel set up alongside each side of the soft-soundproofing core 50.

After STC test is determined in accordance with ASTM E413-10 and E90-09, the result is that the soundproof door of the Example 1 has an STC of 38 (or STC 38) for door.

### EXAMPLE 2

A soundproof door assembled as the same specification as that of soundproof door of Example 1, in addition to the soft-soundproofing core 50 made of phenolic foaming board used to replace the rock wool fiber board used in Example 1.

After STC test is determined in accordance with ASTM E413-10 and E90-09, the result is that the soundproof door of the Example 2 has an STC 33 for door.

What is claimed is:

1. A soundproof door for use in reduction of sound transmitted from one side of the door to the other side, having a thickness of 30-70 mm as well as having an STC number greater than of STC 30 determined in accordance with ASTM E413-10 and E90-09, comprising
two door skins one formed as a front door skin and the other formed as a rear door skin for the soundproof door respectively, and
a quadrilateral frame constituted by a top rail member, a bottom rail member, a left stile member and a right stile member to seal the perimeter of the door skins;
wherein the improvement comprises:
a multiple-layered core to form a concrete inner portion of the door, which comprising;
two spaced hard-soundproofing cores each formed as a single-layered soundproofing core having a thickness of 3-12 mm and made of wood plate, iron plate, calcium silicate board, gypsum board, magnesium oxide board, silicon magnesium board, glass fiber composite board or ceramic composite board; and
a soft-soundproofing core interleaved in between the spaced hard-soundproofing cores to constitute with a sandwich structure, and the soft-soundproofing core is made of rock wool fiber board, ceramic fiber wool board, phenolic foaming board, glass fiber board, closed cell polyurethane foaming board, opened cell polyurethane foaming board, expandable polystyrene foaming board or expandable polyethylene foaming board.

2. The soundproof door as described in claim 1, wherein one of the two spaced hard-soundproofing cores is formed as a multiple-layered soundproofing core constituted by two or more the single-layered soundproofing cores.

3. The soundproof door as described in claim 1, wherein the multiple-layered core further comprises one or more reinforced members in parallel set up alongside one or more sides of the soft-soundproofing core, and both the soft-soundproofing core and each the reinforced member are interleaved in between the two spaced hard-soundproofing cores to constitute with a sandwich structure.

4. The soundproof door as described in claim 3, wherein the reinforced member is made of hard PVC board, PVC composite extrusion board, PS board, ABS board, hardwood board, high density particle board or LVL board.

5. The soundproof door as described in claim 3, wherein one of the two spaced hard-soundproofing cores is formed as a multiple-layered soundproofing core constituted by two or more the single-layered soundproofing cores.

6. A soundproof door for use in reduction of sound transmitted from one side of the door to the other side, having a thickness of 30-70 mm as well as having an STC number greater than of STC 30 determined in accordance with ASTM E413-10 and E90-09, comprising
two door skins one formed as a front door skin and the other formed as a rear door skin for the soundproof door respectively, and
a quadrilateral frame constituted by a top rail member, a bottom rail member, a left stile member and a right stile member to seal the perimeter of the door skins;
wherein the improvement comprises:
one or more reinforced members in parallel set up alongside one or more inner sides of the quadrilateral frame;
a multiple-layered core to form a concrete inner portion of the door, which comprising;
two spaced hard-soundproofing cores each formed as a single-layered soundproofing core having a thickness of 3-12 mm and made of wood plate, iron plate, calcium silicate board, gypsum board, magnesium oxide board, silicon magnesium board, glass fiber composite board or ceramic composite board; and
a soft-soundproofing core interleaved in between the spaced hard-soundproofing cores to constitute with a sandwich structure, and the soft-soundproofing core is made of rock wool fiber board, ceramic fiber wool board, phenolic foaming board, glass fiber board, closed cell polyurethane foaming board, opened cell polyurethane foaming board, expandable polystyrene foaming board or expandable polyethylene foaming board.

7. The soundproof door as described in claim 6, wherein one of the two spaced hard-soundproofing cores is formed as a multiple-layered soundproofing core constituted by two or more the single-layered soundproofing cores.
